(19) United States
(12) Patent Application Publication
(10) Pub. No.: US 2009/0017428 A1
(43) Pub. Date: Jan. 15, 2009

(54) EDUCATION BUSINESS TEACHING MODEL

(76) Inventor: Ned R. Piccinini, Washington, MI (US)

Correspondence Address: REISING, ETHINGTON, BARNES, KISSELLE, P.C., P O BOX 4390, TROY, MI, 48099-4390, US

(21) Appl. No.: 12/169,944

(22) Filed: Jul. 9, 2008

Related U.S. Application Data
(60) Provisional application No. 60/948,515, filed on Jul. 9, 2007.

(51) Int. Cl. G09B 19/00

(52) U.S. Cl. 434/219

(57) ABSTRACT

An education business teaching model is provided that enhances learning with sound content, uniformity of presentation and testing, reliability, and thorough evaluation. The teaching model provides customized content that delivers results in skills, knowledge, and attitude in diverse settings, across diverse industries, audiences and learning environments. The education business teaching model provides a step by step procedure for constructing, reviewing, and teaching the teaching model to individuals and/or business groups. The education training model is developed in several stages, including content design, non-video asset development, video shooting and editing, and media development stages having quality assurance reviews that provide a final content available to the end user.

### CROSS REFERENCE TO RELATED APPLICATIONS

The present invention claims priority from U.S. Provisional Application No. 60/948,515, filed Jul. 9, 2007 and entitled “Education Business Teaching Model.”

### TECHNICAL FIELD

A business teaching model, and more specifically to an education business teaching model.

### BACKGROUND OF THE INVENTION

Retooling a workforce to compete in today's marketplace isn't always easy. It can be financially taxing and time consuming to a business. Today's learning solutions prove their business worth with respect to overall cost and effectiveness for mission-essential corporate training, continuing education and business-to-business, business-to-consumer and business-to-media goals.

Whether it is human resources, sales and marketing, mandatory training or continuing education to upgrade skills, across a computer screen or across the globe, learning solutions can powerfully convey a company's strategic messages with clarity, impact and style.

Too often mandatory training or continuing education do not achieve any true lasting and measurable impact to a company's business. One deficiency is that the training is overly broad, and is not geared towards addressing a particular point of emphasis with a company's overall business goals. For example, the training received does not include a concise procedure that allows for immediate implementation.

Another deficiency is that there is no follow up, in terms of measurement devices that use subject-specific key performance metrics, to determine whether the training has achieved the desired effect.

### SUMMARY OF THE INVENTION

In one exemplary embodiment, an education business teaching model may enhance learning with sound content, uniformity of presentation and testing, reliability, and thorough evaluation. The exemplary embodiment may provide customized content that delivers results in skills, knowledge, and attitude in diverse settings, across diverse industries, audiences and learning environments.

The exemplary embodiment may develop content with an eye toward cost-effective, multiple use. The exemplary embodiment may facilitate the re-purposing of learning elements for multiple platform delivery and blended learning strategies.

The exemplary embodiment may describe a development process for implementing a specific video-based educational business teaching model having several stages. The first stage of development may be content design, in which the generation and structure of the subject matter to be presented may be formalized. Next, in the asset development stage, the design and development of documents, interactive or hard-copy quizzes, content-specific tools, measurement tools, or other reinforcement job aids may be created, modified, and incorporated into a prototype media. Next, a quality assurance stage may be performed to evaluate and assure the quality of non-video assets for instructional soundness, usability to the learner, and any other desired quality metric. In conjunction with the asset development stage, a video shoot may be performed, which includes all the pre-production steps necessary to accomplish the video shoot, including script review, talent and crew identification, prop development, and shoot location are determined. After shooting the video, a video editing stage may be performed, wherein the capture of film is captured from tape to a digital format, edited, and graphically treated, and export to an appropriate video export setting for introduction to an appropriate media. Next, a second quality assurance stage may be performed, which reviews and evaluates the quality of the video assets for instructional soundness and usability to the learner. Next, a media development stage may be performed, which ultimately results in the final resource being made available to the end user. A third quality assurance stage may then be performed with the end user to evaluate and assure the overall content of the educational tool for instructional soundness and usability to the learner. Once this step is performed, the end user may provide final approval of the internal design and development of the education business training tool and may allow the posting of the education business training tool to the web or duplication onto a media. Finally, the approved and finished education business training tool may be shipped or otherwise provided to the client or end user for use.

By adhering to a content development model that aligns learning objectives with the business goals of clients, the exemplary embodiment's instructionally sound learning solutions may positively affect the bottom line of companies or other end users that utilize the techniques of the exemplary embodiment.

Other advantages and features of the present invention will become apparent when viewed in light of the detailed description and preferred embodiment when taken in conjunction with the attached drawings and claims.

### BRIEF DESCRIPTION OF THE DRAWINGS

FIG. 1 is a high level logic flow diagram for the development of an educational training tool in accordance with a preferred embodiment of the present invention;

FIG. 2 is a detailed logic flow diagram for the content design portion of FIG. 1;

FIG. 3 is a detailed logic flow diagram for the asset development portion of FIG. 1;

FIG. 4 is a detailed logic flow diagram for the video shoot portion of FIG. 1;

FIG. 5 is a detailed logic flow diagram for the video editing portion of FIG. 1; and

FIG. 6 is a detailed logic flow diagram for the media development portion of FIG. 1.

### DETAILED DESCRIPTION OF PREFERRED EMBODIMENT

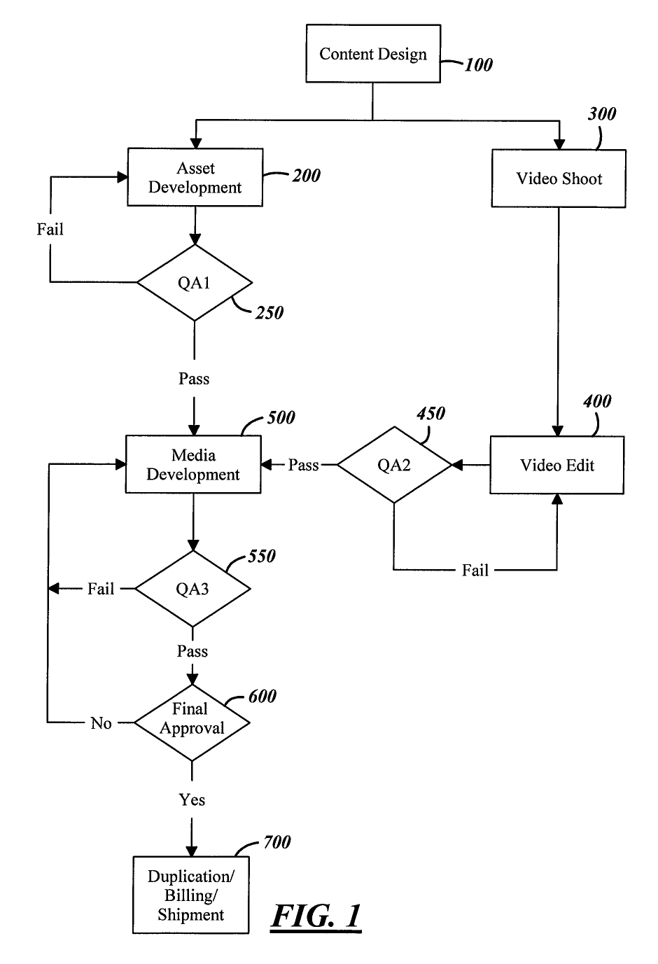

Referring now to the FIG. 1, a high level logic flow diagram that may be used to create and implement an educational business training tool in accordance with an exemplary embodiment of the present invention is illustrated.

The process for forming the educational business training tool according to one exemplary embodiment may begin with Step 100, wherein the content design may be created, which entails the generation of subject matter through the identification of all assets.

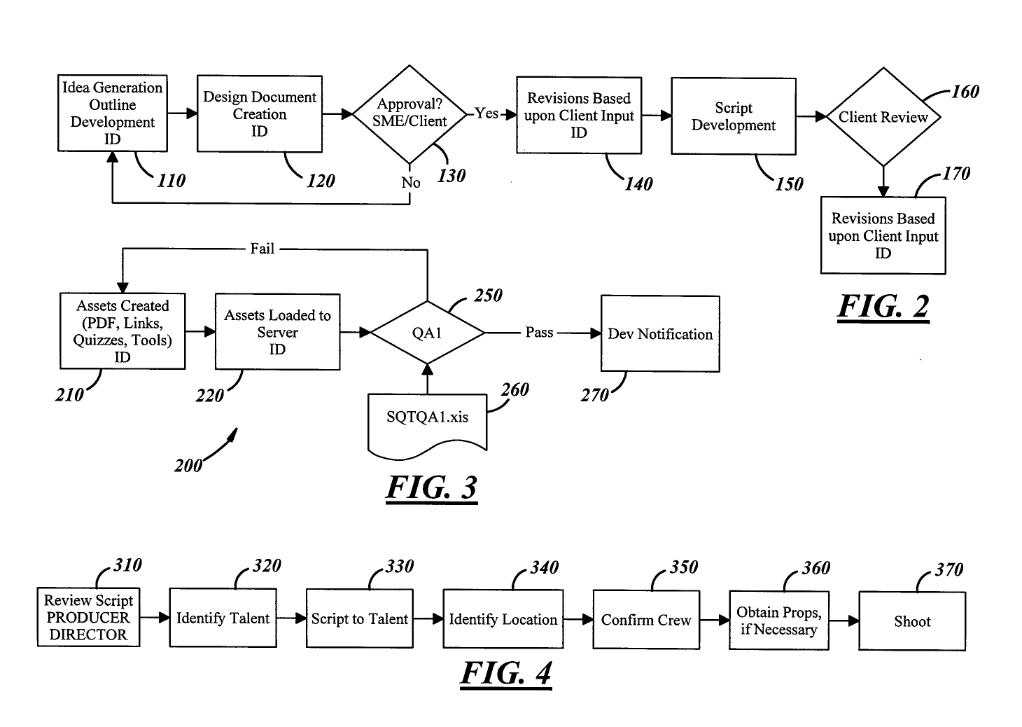

Beginning with Step 110 as shown in FIG. 2, an idea for an educational business training tool may be generated based on research and subject matter expert (SME) input for the applicable content area. An outline may be created based upon the idea generated that may be based upon the needs of the specific audience and content area for training on a particular technical or non-technical subject matter.

In Step 120, a design document may be created that outlines the specifics from the outline. The design document may include a working title, purpose, objective or objectives, audience, identified values to the audience, procedure, listing information identification, and other information that may be useful with regards to the particular subject matter.

In Step 130, the design document may be reviewed and approved for content from the creator or other individuals and given approval to move forward. If no approval given, the process reverts back to Step 110 to revise or revamp the idea.

In Step 140, the design document revisions may be incorporated based on feedback from the SME. In Step 150, a script may be developed based on the design document revisions. The script is a text that may be read verbatim, or substantially verbatim, by an on-camera talent during subsequent filming of a video shoot.

In Step 160, the script may be reviewed for approval by a client, company or other end user (collectively the “end user”). In addition, the script may be reviewed by the SME. The script may then be revised, in Step 170, if necessary, by incorporating comments of the SME and end user. The script may then be approved and made available for the video shoot, as will be described further below.

Next, in Step 200, the non-video assets may be developed. In coordination, as shown in Step 300, a video shoot based on the approved script may be performed. Each is described below.

Referring first to FIG. 3, beginning with Step 210, the non-video assets may be created. This may include the design and development of documents, interactive or hard-copy quizzes, content-specific tools (including programs and spreadsheets), measurement tools (such as pre-configured spread sheets), or other reinforcement job aids.

In Step 220, these non-video assets may be loaded onto a server for inclusion into a final media (web-based, CD-ROM, DVD-ROM or other media).

In Step 250, each of the non-video assets may be reviewed and evaluated for quality purposes to assure their instructional soundness and usability to the learner. As shown in Step 260, a preformed questionnaire may be used to aid the evaluation performed in Step 250. Once the non-video assets are approved, as shown in Step 270, a development notification may be sent from the development team to the project management.

In conjunction or coordination with the non-video asset development described in Step 200 and in FIG. 3 may be the performance of a video shoot, which may be the actual on-location capture of video which incorporates the script. This is described in FIG. 4.

Referring now to FIG. 4, the video shoot may begin with Step 310, wherein the producer and director may first review the approved script. The producer and director may then hire the talent to narrate the video shoot (Step 320), deliver the approved script to the talent for review and practice purposes (Step 330), identify a time and location for the video shoot (Step 340), confirm a crew and resources necessary to perform the video shoot (Step 350), obtain any props or other accessories (Step 360), and eventually film the video shoot (Step 370), wherein the talent performs or otherwise narrates the script.

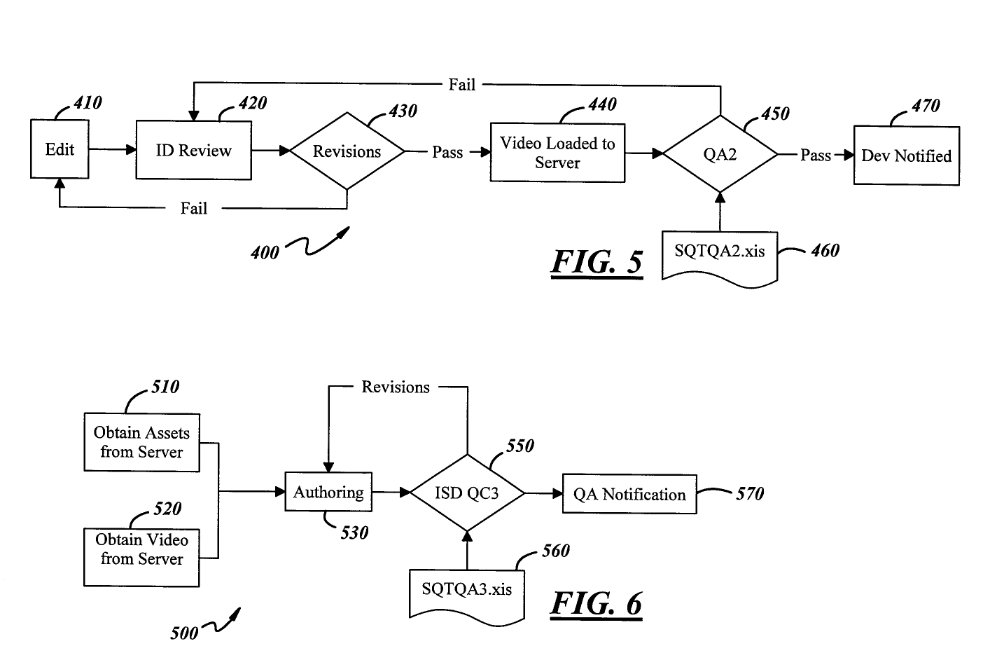

Next, in Step 400 and as shown in detail in FIG. 5, the video shoot may be edited into its final form and loaded to a server to transfer the final video element to a development team for review.

The editing of the video shoot begins at Step 410 of FIG. 5, wherein the video shoot may first be captured from tape to a digital format. The captured video may be edited for content, graphically treated and enhanced, and exported to the appropriate video export setting, depending upon the final media delivery (web, CD-ROM, DVD-ROM, etc.).

Next, in Step 420, an identification (ID) review may be performed, wherein the exported video may be reviewed by the script writer, instructional designer, or other individuals to confirm that the intent of the script was carried through and that the appropriate graphical elements were introduced to reinforce the instruction provided on the video feed.

In Step 430, any revisions to the ID review may be incorporated into the captured and exported video. In Step 440, the revised video may be loaded onto a server, which transfers possession of the final video element to the development team.

Next, in Step 450, the final video element may be evaluated by the development team and others to ensure the final video element for instructional soundness and usability to the learner. To aid in the process, as shown in Step 460, a preformed questionnaire may be used. This process may include an itemized correction log and authorization. If the final video element is authorized, as shown in Step 470, a notification may be sent from the quality assurance product manager to the development team. If authorization is not given, the process reverts back to Step 420 for further review and possible modification.

Next, in Step 500, the non-video assets developed in Step 200 and the final video element shot and edited in Steps 300 and 400 may be processed to form the non-finalized educational business training tool, a step known as media development.

Referring now to FIG. 6, the media development begins with Steps 510 and 520, wherein the non-video assets and final video element may be gathered from the server. Next, in Step 530, the non-video assets and final video element may be coordinated into the non-final education business training tool utilizing a software program, a process called authoring.

In Step 550, the non-final education business training tool may be evaluated by the development team and others to ensure that it meets the qualities desired for instructional soundness and usability to the learner. To aid in the process, as shown in Step 560, a preformed questionnaire may be used. If the non-final education business training tool meets the expectations, a quality assurance (QA) notification may be sent to the project manager.

In Step 600, the non-final education business training tool may be reviewed by the end user, or SME, or both, and the results, in terms of an approval or non-approval, may be communicated to the project manager. If approval is not granted, the process reverts back to Step 500 for further editing or correction.

If final approval is granted by the end user and/or by the SME, or both the end user and the SME, a final version of the training tool, hereinafter referred to as a final education business training tool, may be posted on the web or duplicated onto media such as a CD-ROM, a DVD, or other portable recording and playback device for distribution to the end user. A billing statement to the end user may then be generated.

The final education business training tool may then be utilized by the end user to train one or more individuals, such as employees or colleagues, on the technical and non-technical business subjects providing therein. One or more manuals, written document and the like may be used in conjunction with the visual presentation of the education business training tool and the other non-video assets included within the final education business training tool to enhance what is presented on the final education business training tool. This training may be in the form of a seminar or classroom training experience, wherein the individuals view the final education business training tool on a visual medium such as a computer or television.

The exemplary embodiment may develop content with an eye toward cost-effective, multiple use. The exemplary embodiment may facilitate the re-purposing of learning elements for multiple platform delivery and blended learning strategies.

By adhering to a content development model that aligns learning objectives with the business goals of clients, the exemplary embodiment's instructionally sound learning solutions may positively affecting the bottom line of companies or other end users that utilize the techniques of the exemplary embodiment.

The exemplary embodiment may be available to a wide variety of business applications and for a wide variety of technical and non-technical business subjects. The education business training tool may be utilized to help in all aspects of a business, including sales, marketing, operations, customer service, and the like. Because the information is provided to the end user in many formats, including CD-ROMS, for example, the end user may be free to review the training tools over and over at their leisure to the same or different individuals, or to share the information with other businesses, consumers or groups. Moreover, the education business training tool may provide definitive procedures, and provides feedback and measurement tools that confirm the benefits of the training.

While particular embodiments of the invention have been shown and described, numerous variations and alternate embodiments will occur to those skilled in the art.

1. A method comprising:
creating a content design by generating subject matter through the identification of all assets;
developing one or more non-video assets based on said content design;
developing one or more video assets based on said content design;
forming a non-finalized educational business training tool based on said one or more non-video assets and said one or more video assets;
evaluating said non-finalized educational business training tool for instructional soundness and usability;
reviewing of said non-finalized educational business training tool for final approval; and
release of a final education based training tool to an end user.

2. The method of claim 1, wherein creating a content design comprises:
generating an idea for an educational business training tool based on research and subject matter expert input;
creating a design document that outlines said idea;
reviewing said design document for content approval;
revising said design document after review from a subject matter expert;
creating a script from said revised design document;
approving said script from one or more sources; and
making said script available for a video shoot.

3. The method of claim 2 further comprising:
revising said script after review from said subject matter expert.

4. The method of claim 1, wherein developing one or more non-video assets comprises:
determining a content of said one or more non-video assets;
creating said content in a downloadable media;
loading said content onto a server; and
reviewing said content for quality purposes and usability.

5. The method of claim 4, wherein said content is in the form of one of the group consisting of documents, interactive quizzes, hard-copy quizzes, content-specific tools, measurement tools, and reinforcement job aids.

6. The method of claim 1, wherein developing one or more video assets based on said content design comprises:
reviewing said script for a video shoot;
hiring talent to narrate said video shoot;
identifying a time and a location for said video shoot;
confirming additional resources necessary to effectuate said video shoot;
obtaining any props or accessories for use in conjunction with said video shoot; and
filming said video shoot.

7. The method of claim 6, further comprising:
capturing said filmed video shoot to a digital format;
editing said digital format for content;
graphically treating said digital format with one or more graphical enhancements; and
exporting said digital format as a captured and exported video to an appropriate video export setting.

8. The method of claim 7 further comprising;
reviewing said captured and exported video in said appropriate video export setting to confirm the intent of said script was carried through on said captured and exported video;
reviewing whether said one or more graphical enhancements reinforce an instruction provided on said captured and exported video; and
introducing one or more revisions onto said captured and exported video.

9. The method of claim 1, wherein forming a non-finalized educational business training tool based on said one or more non-video assets and said one or more video assets comprises:
gathering said one or more video assets and one or more non-video assets from said server; and
authoring said one or more video assets and one or more non-video assets into a non-finalized educational business training tool.

10. The method of claim 1, wherein evaluating said non-finalized educational business training tool for instructional soundness and usability comprises:
providing said non-finalized educational business tool to a development team;
evaluating the instructional soundness and usability of said non-finalized educational business training tool using a preformed questionnaire; and
sending a quality assurance notification to a project manager if said non-finalized educational business training tool meets expectations for instructional soundness and usability.

11. The method of claim 1, wherein reviewing of said non-finalized educational business training tool for final approval comprises:
providing said non-finalized educational business tool to an end user for final approval; and
communicating an approval or non-approval from said end user to a project manager.

12. The method of claim 1, wherein reviewing of said non-finalized educational business training tool for final approval comprises:
providing said non-finalized educational business tool to a subject matter expert for final approval; and
communicating an approval or non-approval from said subject matter expert to a project manager.

13. The method of claim 1, wherein reviewing of said non-finalized educational business training tool for final approval comprises:
providing said non-finalized educational business tool to a subject matter expert and an end user for final approval; and
communicating an approval or non-approval from said subject matter expert and said end user to a project manager.

14. The method of claim 1, wherein the release of a final education based training tool to an end user comprises:
posting a final education based training tool on a website accessible by an end user.

15. The method of claim 1, wherein the release of a final education based training tool to an end user comprises:
duplicating a final education based training tool on a media; and
distributing said media to an end user.

16. The method of claim 15, wherein said media is selected from the group consisting of a CD-ROM, a DVD, or other portable recording and playback device.

17. The method of claim 1 further comprising utilizing said media to train one or more individuals.

18. An educational training seminar utilizing the final education based training tool of claim 1.

19. The educational training seminar of claim 18 further comprising one or more written documents to be used in conjunction with the final education based training tool.

20. The educational training seminar of claim 19, wherein said one or more written documents comprises one or more manuals.
